(19) United States
(12) Patent Application Publication
(10) Pub. No.: US 2026/0146650 A1
(43) Pub. Date: May 28, 2026

(54) BEARING CAGE WITH AXIAL LUBRICANT PASSAGES

(71) Applicant: AKTIEBOLAGET SKF, GOTEBORG (SE)

(72) Inventors: Bryan D. ALLISON, Clymer, NY (US); Brian LARSEN, Scottville, MI (US)

(21) Appl. No.: 18/959,986

(22) Filed: Nov. 26, 2024

(51) Int. Cl. F16C 33/66; F16C 33/44

(52) U.S. Cl. CPC F16C 33/6614; F16C 33/6629

(57) ABSTRACT

A cage is for a bearing including an inner body, an outer body and a plurality of rolling elements disposed within an annular space between the bodies and rollable simultaneously upon an inner raceway surface and an outer raceway surface. The cage includes an annular body disposeable between the inner body and the outer body and having a centerline and first and second axial ends spaced apart along the centerline. The body includes a plurality of pockets spaced circumferentially about the centerline, each pocket being configured to retain a separate one of the plurality of rolling elements. The body also includes a plurality of axial passages, each one of the plurality of axial passages extending at least partially between one of the first and second axial ends of the annular body and one of the plurality of pockets and being configured to retain a quantity of grease.

### BACKGROUND OF THE INVENTION

The present invention relates to bearings, and more particularly to rolling element bearings having cages.

Rolling element bearings are well known and include an inner body having an inner raceway surface, an outer body having an outer raceway surface and a plurality of rolling elements disposed between and radially coupling the inner and outer bodies so as to rotatably couple an inner member, such as a shaft, etc., with an outer member, such as a housing, a wheel hub, etc. Certain rolling element bearings include a cage for maintaining a desired circumferential spacing between the rolling elements, which may be balls, cylinders, spheroids, etc. Specifically, the cage includes a plurality of circumferentially spaced pockets, which may be entirely enclosed or have an open axial side, and each rolling element is disposed within a separate one of the pockets.

Typically, a lubricant such as oil or grease is provided within the space between the inner and outer bodies of the bearing in order to reduce friction between the points of contact between the rolling elements and the raceway surfaces, as well as between the rolling elements and the surfaces of the cage pockets. However, in certain applications such as semiconductor manufacturing, the type of lubricant is generally restricted to specific types of grease which can withstand vacuum environments. Also, the amount of such grease is limited in order to avoid the grease from passing out of the bearing and causing contamination. Normally, a bearing typically has 30% to 40% of the free volume between the inner and outer bodies filled with grease, but in these applications, the amount of grease is limited to about 10% of the free volume.

As a result, when the limited amount of grease breaks down, the grease loses the ability to adequately lubricate the contact points until friction torque becomes excessive and/or the locating accuracy of the bearing is reduced to below acceptable levels. At either point, the bearing is typically replaced.

### SUMMARY OF THE INVENTION

In an aspect, the present invention is a cage for a bearing, the bearing including an inner body having an inner raceway surface and an outer body disposed about the inner body so as to define an annular space, the outer body having an outer raceway surface. A plurality of rolling elements are disposed within the annular space and are rollable simultaneously upon the inner raceway surface and the outer raceway surface. The cage comprises an annular body disposeable between the inner body and the outer body and having a centerline and first and second axial ends spaced apart along the centerline. The body includes a plurality of pockets spaced circumferentially about the centerline, each pocket being configured to retain a separate one of the plurality of rolling elements. Further, the body also includes a plurality of axial passages, each one of the plurality of axial passages extending between one of the first and second axial ends of the annular body and one of the plurality of pockets and being configured to retain a quantity of grease.

Preferably, each one of the plurality of axial passages is bounded by an enclosed cylindrical surface and has a first opening at one of the first and second axial ends of the annular body and a second opening at a connected one of the plurality of pockets. Also, each one of the plurality of axial passages is preferably configured to enable displacement of grease from one of the first and second axial ends of the annular body and into a connected one of the plurality of pockets. Further, one or more of the plurality of axial passages preferably intersect one circumferential end of one of the plurality of pockets and each has a circular opening at one of the first and second axial ends of the annular body and an elliptical opening at the one circumferential end of the one of the plurality of pockets. Furthermore, the plurality of axial passages preferably includes a first set of axial passages each extending between the first axial end of the annular body and a separate one of the plurality of pockets and a second set of axial passages each extending between the second axial end of the annular body and a separate one of the plurality of pockets.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, axial cross-sectional view of a bearing with a cage having axial passages in accordance with the present invention, shown mounted between a shaft and a housing;

FIG. 2 is a perspective view of the present cage;

FIG. 3 is a broken-away, enlarged perspective view of a portion of the present cage;

FIG. 4 is a broken-away, enlarged perspective view of another portion of the present cage;

FIG. 5 is a broken-away, more enlarged front plan view of the cage, showing one pocket with three axial passages; and

FIG. 6 is another broken-away, more enlarged front plan view of the cage, showing one pocket with three blind axial passages.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description.

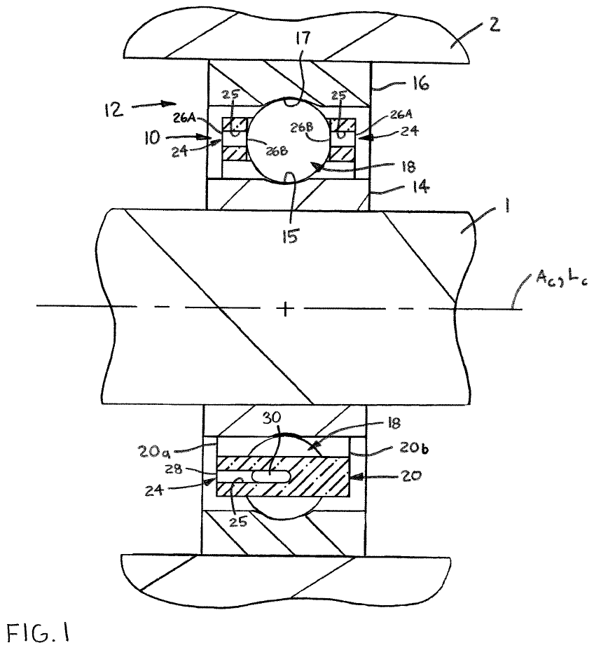

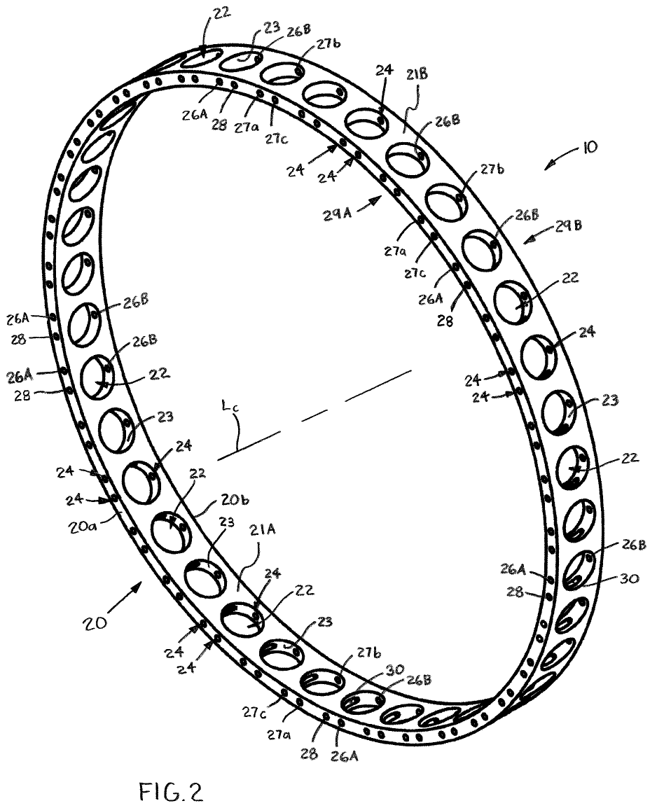

Referring now to the drawings in detail, wherein like numbers are used to indicate like elements throughout, there is shown in FIGS. 1-6 a cage 10 for a bearing 12 that is preferably used in a vacuum or other specialty environment, in particular for microchip manufacturing. The bearing 12 includes an inner body 14 having an inner raceway surface 15 and an outer body 16 disposed about the inner body 14 so as to define an interior annular space S, the outer body 16 having an outer raceway surface 17, at least one of the inner and outer bodies 14, 16 being rotatable about the central axis A_{C}. Preferably, the inner and outer bodies 14, 16 are each formed as a ring, but one or both may be formed in any other appropriate manner, such as a hub, a sleeve, a housing, etc., the inner body/ring 14 being installed about an inner member 1, such as a shaft, and the outer body/ring 16 being installed within an outer member 2, such as a housing. Further, a plurality of rolling elements 18 are disposed within the annular space S and are each rollable simultaneously upon the inner raceway surface 15 and the outer raceway surface 17. The rolling elements 18 are preferably balls, but may be cylindrical rollers, tapered rollers, spherical rollers, needles, or any other appropriate type of rolling element.

The cage 10 comprises an annular body 20 disposeable within the annular space S between the inner body 14 and the outer body 16, the body 20 having a centerline L_{C}, an inner circumferential surface 21A, an opposing outer circumferential surface 21B and first and second opposing axial ends 20a, 20b, respectively. The body 20 includes a plurality of pockets 22 spaced circumferentially about the centerline L_{C}, each pocket 22 being configured to retain a separate one of the plurality of rolling elements 18 and establishes a desired spacing distance (not indicated) between the rolling elements 18. Each one of the plurality of pockets 22 has a geometric center (not indicated), is bounded by a radial surface 23 extending at least partially around the center, and has two opposing circumferential ends 22a, 22b and two opposing axial sides 22c, 22d.

Further, the cage body 20 has a plurality of axial passages 24, each one of axial passages 24 extending between one of the first and second axial ends of 20a or 20b of the annular body 20 and one of the plurality of pockets 22. Each one of the plurality of axial passages 24 is disposed radially between and spaced apart from each one of the inner circumferential surface 21A and the outer circumferential surface 21B of the cage body 20. As such, each passage 24 is entirely enclosed within the body 20, and is thus fluidly isolated or separated from the inner and outer surfaces 21A, 21B of the body 20.

Further, each one of the plurality of axial passages 24 is configured to retain lubricant, preferably grease, such that the grease is available for lubricating the points of contact between each pocket 22 and the rolling element 18 contained therein, as well as being transferred to the raceways 15, 17 to lubricate the points of contact between the rolling elements 18 and the raceways 15, 17. Specifically, when the bearing 12 is lubricated prior to use in a particular application or relubricated during a service operation, a certain quantity of the lubricant becomes disposed within the axial passages 24. Preferably, the passages 24 may also be used to inject lubricant into the pockets 22, after which a portion of the lubricant remains in each axial passage 24. Specifically, each axial passage 24 is preferably configured to enable displacement of grease from one of the first and second axial ends 20a or 20b of the cage annular body 20 and into a connected one of the plurality of pockets 22, such that the passages 24 may be used to directly inject lubricant into the pockets 22.

In either case, the lubricant is thus stored within the axial passages 24 and is available for use after the breakdown or dissipation of lubricant applied directly to points of contact between the cage 10 and the rolling elements 18 or between the rolling elements 18 and the raceways 15, 17. Therefore, forming the cage 10 with the axial passages 24 both prolongs the service time between required relubrication of the bearing 12 and extends the overall life of the bearing 12.

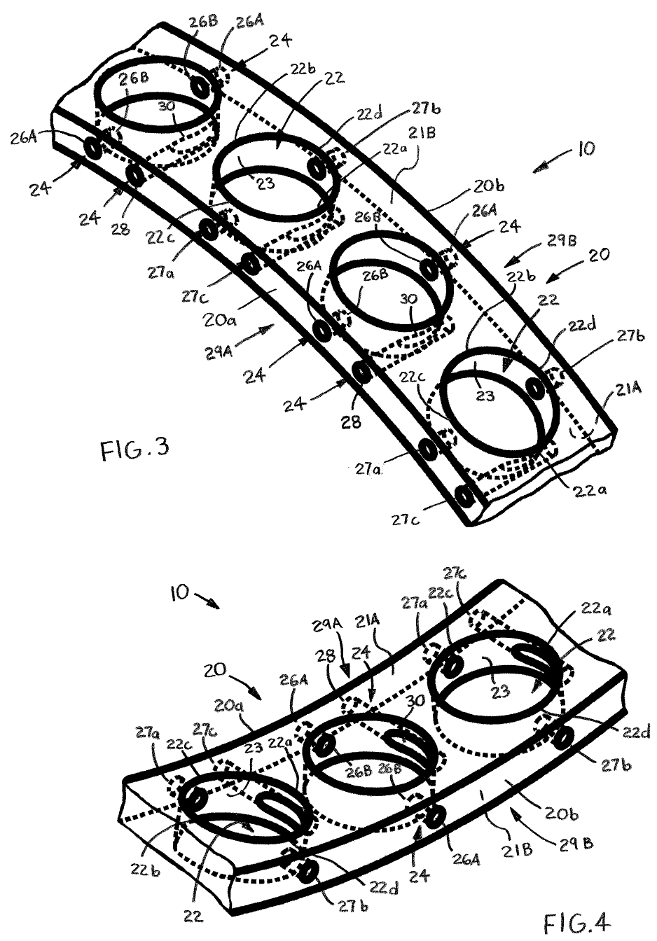

Referring to FIGS. 3-6, each axial passage 24 is preferably bounded by an enclosed cylindrical surface 25 extending axially between one axial end 20a, 20b of the cage body 20 and the connected one of the plurality of pockets 22. More specifically, each passage 24 intersects one axial side 22c or 22d of the connected pocket 22 or one circumferential end 22a or 22b of the pocket 22. In the former case, each axial passage 24 has a first circular opening 26A at one axial end 20a or 22b of the body 20 and a second circular opening 26B at one axial side 22c or 22d of the connected pocket 22. In the latter case, each axial passage 24 has a circular opening 28 at one axial end 20a or 22b of the body 20 and an elliptical opening 30 at one circumferential end 22a or 22b of the connected pocket 22.

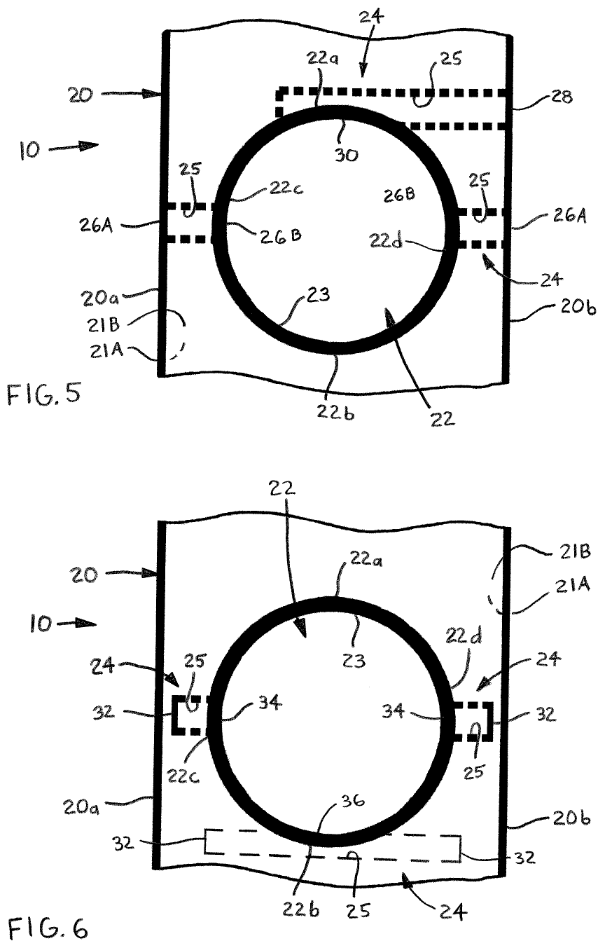

Alternatively, one or more of the axial passages 24 may each extend from one of the pockets 22 toward one axial end 20a or 20b of the cage body 20, but terminating in one or two blind ends 32 spaced from the axial end(s) 20a, 20b, as shown in FIG. 6. Such passage(s) 24 extend only partially, and not entirely, between one body axial end 20a or 20b and the pocket 22. Specifically, such an axial passage 24 has a circular opening 34 or elliptical opening 36 on the radial surface 23 of the pocket 22 and the blind end(s) 32 are each disposed between the pocket 22 and one axial end 20a or 20b of the cage annular body 20. With each such passage 24, lubricant/grease is not injectable into the connected pocket 22 through the passage 24 and the passage 24 is used solely to store grease or other lubricant for subsequent use.

As best shown in FIGS. 3-5, in a presently preferred embodiment, three axial passages 24 extend into each one of the pockets 22. Specifically, a first passage 27a extends between the first axial end 20a of the cage body 20 and the proximal axial side 22c of the connected pocket 22, a second axial passage 27b extends between the body second axial end 20b and the proximal axial side 22d of the pocket 22, and a third passage 27c extends between the body first axial side 20a and intersects one circumferential end 22a or 22b of the connected pocket 22. With this arrangement, the axial passages 24 includes a first set of axial passages 29A which each extend between the first axial end 20a of the annular body and a separate one of the plurality of pockets 22 and a second set of axial passages 29B each extending between the second axial end 20b of the cage body 20 and a separate one of the plurality of pockets 22.

However, the cage 10 may be formed such that the axial passages 24 extend only from one side 20a or 20b of the cage body 20 and/or may extend only to an axial side 22c or 22d of the pockets 22 or only to a pocket circumferential end 22a or 22b. As a further alternative, the cage 10 may include one or more annular covers (not shown) each disposed against one of the axial ends 20a, 20b of the annular body 20 so as to enclose the axial openings 24 extending inwardly from the one axial end 20a or 20b. Such a cover(s) may be provided to ensure that grease or other lubricant flows into the pocket 22 connected with the covered passages 24 and does not leak out one of the axial ends 20a, 20b of the cage annular body 20.

Furthermore, the cage 10 is preferably formed of a polymeric material in a molding process or by additive manufacturing. However, the cage 10 may be formed of any other appropriate material and/or manufacturing process, such as for example, being formed of a metallic material in a stamping process.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A cage for a bearing, the bearing including an inner body having an inner raceway surface, an outer body disposed about the inner body so as to define an annular space, the outer body having an outer raceway surface, and a plurality of rolling elements disposed within the annular space and rollable simultaneously upon the inner raceway surface and the outer raceway surface, the cage comprising:
an annular body disposeable between the inner body and the outer body and having a centerline and first and second axial ends spaced apart along the centerline, the body including a plurality of pockets spaced circumferentially about the centerline, each pocket being configured to retain a separate one of the plurality of rolling elements, and a plurality of axial passages, each one of the plurality of axial passages extending between one of the first and second axial ends of the annular body and one of the plurality of pockets and being configured to retain a quantity of grease.

2. The cage as recited in claim 1, wherein each one of the plurality of axial passages is bounded by an enclosed cylindrical surface and has a first opening at one of the first and second axial ends of the annular body and a second opening at a connected one of the plurality of pockets.

3. The cage as recited in claim 1, wherein each one of the plurality of axial passages is configured to enable displacement of grease from one of the first and second axial ends of the annular body and into a connected one of the plurality of pockets.

4. The cage as recited in claim 1, wherein:
each one of the plurality of pockets has two opposing circumferential ends; and
at least one of the plurality of axial passages intersects one circumferential end of one of the plurality of pockets.

5. The cage as recited in claim 4, wherein at least some of the plurality of axial passages each intersect one circumferential end of a separate one of the plurality of pockets.

6. The cage as recited in claim 4, wherein the at least one axial passage is bounded by an enclosed cylindrical surface and has a circular opening at one of the first and second axial ends of the annular body and an elliptical opening at the one circumferential end of the one of the plurality of pockets.

7. The cage as recited in claim 1, wherein the plurality of axial passages includes a first set of axial passages each extending between the first axial end of the annular body and a separate one of the plurality of pockets and a second set of axial passages each extending between the second axial end of the annular body and a separate one of the plurality of pockets.

8. The cage as recited in claim 1, wherein the annular body has an inner circumferential surface and an outer circumferential surface, each one of the plurality of axial passages being disposed radially between and spaced apart from each one of the inner circumferential surface and the outer circumferential surface.

9. The cage as recited in claim 1, wherein at least one of the plurality of axial passages has an opening at one of the plurality of pockets and a blind end disposed between the pocket and one of the first and second axial ends of the annular body.

10. The cage as recited in claim 1, wherein the annular body is formed of a polymeric material in a molding process or by additive manufacturing.

11. A bearing comprising:
an inner body having an inner raceway surface;
an outer body disposed about the inner body so as to define an annular space, the outer body having an outer raceway surface;
a plurality of rolling elements disposed within the annular space and rollable simultaneously upon the inner raceway surface and the outer raceway surface; and
a cage including an annular body disposed within the annular space between the inner body and the outer body, the cage annular body has a centerline and first and second axial ends spaced apart along the centerline, a plurality of pockets spaced circumferentially about the centerline, each pocket being configured to retain a separate one of the plurality of rolling elements, and a plurality of axial passages, each one of the plurality of axial passages extending between one of the first and second axial ends of the annular body and one of the plurality of pockets and being configured to retain a quantity of grease.

12. The bearing as recited in claim 11, wherein each one of the plurality of axial passages is bounded by an enclosed cylindrical surface and has a first opening at one of the first and second axial ends of the annular body and a second opening at a connected one of the plurality of pockets.

13. The bearing as recited in claim 11, wherein each one of the plurality of axial passages is configured to enable displacement of grease from one of the first and second axial ends of the annular body and into a connected one of the plurality of pockets.

14. The bearing as recited in claim 11, wherein:
each one of the plurality of pockets has two opposing circumferential ends; and
at least one of the plurality of axial passages intersects one circumferential end of one of the plurality of pockets.

15. The bearing as recited in claim 14, wherein at least one of:
at least some of the plurality of axial passages each intersect one circumferential end of a separate one of the plurality of pockets; and
the at least one axial passage is bounded by an enclosed cylindrical surface and has a circular opening at one of the first and second axial ends of the annular body and an elliptical opening at the one circumferential end of the one of the plurality of pockets.

16. The bearing as recited in claim 11, wherein the plurality of axial passages includes a first set of axial passages each extending between the first axial end of the annular body and a separate one of the plurality of pockets and a second set of axial passages each extending between the second axial end of the annular body and a separate one of the plurality of pockets.

17. The bearing as recited in claim 11, wherein the annular body of the cage has an inner circumferential surface and an outer circumferential surface, each one of the plurality of axial passages being disposed radially between and spaced apart from each one of the inner circumferential surface and the outer circumferential surface.

18. The bearing as recited in claim 11, wherein at least one of the plurality of axial passages has an opening at one of the plurality of pockets and a blind end disposed between the pocket and one of the first and second axial ends of the annular body.

19. The bearing as recited in claim 11, wherein the annular body is formed of a polymeric material in a molding process or by additive manufacturing.
